(19) United States
(12) Patent Application Publication
(10) Pub. No.: US 2026/0216814 A1
(43) Pub. Date: Jul. 30, 2026

(54) WIRE FEED SYSTEM FOR WIRE BONDING SOLAR CELLS

(71) Applicant: Maxeon Solar Pte. Ltd., Singapore (SG)

(72) Inventors: RICHARD HAMILTON SEWELL, Los Altos, CA (US); TODD R. JOHNSON, San Jose, CA (US); COLIN MARTIN, Soquel, CA (US); SAGAR DALVI, Fremont, CA (US)

(21) Appl. No.: 19/452,121

(22) Filed: Jan. 16, 2026

Related U.S. Application Data
(60) Provisional application No. 63/751,777, filed on Jan. 30, 2025.

(51) Int. Cl. B23K 20/00; B23K 20/26; B65H 49/00; B65H 51/08

(52) U.S. Cl. CPC B23K 20/004; B23K 20/26; B65H 49/00; B65H 51/08; B65H 2301/5123; B65H 2801/87

(57) ABSTRACT

Embodiments described herein relate to an apparatus that includes a creel assembly that is configured to support a plurality of spools that each store an electrically conductive wire. In an embodiment, the apparatus includes a coarse pitch assembly that includes a plurality of coarse pitch combs, where two or more of the coarse pitch combs are provided at different horizontal planes. In an embodiment, the apparatus further comprises a fine pitch comb and a compression roller. In an embodiment, the apparatus is configured to feed the electrically conductive wire from each spool in the creel assembly to the compression roller, and the electrically conductive wire from each creel is configured to pass through the coarse pitch assembly and the fine pitch comb before reaching the compression roller.

### CROSS-REFERENCE TO RELATED APPLICATIONS

This application claims benefit of U.S. Provisional Patent Application No. 63/751,777, filed on Jan. 30, 2025, the entire contents of which are hereby incorporated by reference herein.

### BACKGROUND

### 1) Field

Embodiments relate to the field of renewable energy, and in particular, include wire feed systems for wire bonding solar cells.

### 2) Description of Related Art

Semiconductor Photovoltaic cells, commonly known as solar cells, are well known devices for direct conversion of solar radiation into electrical energy. Generally, solar cells are fabricated on a semiconductor wafer or substrate using semiconductor processing techniques to form a p-n junction near a surface of the substrate. Solar radiation impinging on the surface of, and entering into, the substrate creates electron and hole pairs in the bulk of the substrate. The electron and hole pairs migrate to p-doped and n-doped regions in the substrate, thereby generating a voltage differential between the doped regions. The doped regions are connected to conductive regions on the solar cell to direct an electrical current from the cell to an external circuit coupled thereto. Electrical conversion efficiency is an important characteristic of a solar cell as it is directly related to the capability of the solar cell to generate power; with higher efficiency providing additional value to the end customer; and, with all other things equal, higher efficiency also reduces manufacturing cost per Watt. Likewise, simplified manufacturing approaches provide an opportunity to lower manufacturing costs by reducing the cost per unit produced. Accordingly, techniques for increasing the efficiency of solar cells and techniques for simplifying the manufacturing of solar cells are generally desirable.

### BRIEF DESCRIPTION OF THE DRAWINGS

FIGS. 1A-1C illustrate plan views of various stages in a metallization and stringing method for back-contact solar cells, in accordance with an embodiment of the present disclosure.

FIG. 2 illustrates a string of solar cells, in accordance with an embodiment of the present disclosure.

FIG. 3 illustrates a wire feed and bonding system for stringing solar cells in a high-volume assembly environment, in accordance with an embodiment of the present disclosure.

FIGS. 4A-4H illustrate various views of a wire feed and bonding system that depict a process for feeding wires through the wire feed region in order to translate a coarse pitch for the wires to a fine pitch for the wires, in accordance with an embodiment of the present disclosure.

FIG. 5 illustrates a plan view of a wire feed and bonding system that shows the grooves on the feed roller and the compression roller, in accordance with an embodiment of the present disclosure.

### DETAILED DESCRIPTION

Wire-based metallization and stringing techniques for solar cells, and the resulting solar cells, modules, and equipment used to provide the wire-based metallization, are described herein. In the following description, numerous specific details are set forth in order to provide a thorough understanding of embodiments. It will be apparent to one skilled in the art that embodiments may be practiced without these specific details. In other instances, well-known aspects are not described in detail in order to not unnecessarily obscure embodiments. Furthermore, it is to be understood that the various embodiments shown in the accompanying drawings are illustrative representations and are not necessarily drawn to scale.

Various embodiments or aspects of the disclosure are described herein. In some implementations, the different embodiments are practiced separately. However, embodiments are not limited to embodiments being practiced in isolation. For example, two or more different embodiments can be combined together in order to be practiced as a single device, process, structure, or the like. The entirety of various embodiments can be combined together in some instances. In other instances, portions of a first embodiment can be combined with portions of one or more different embodiments. For example, a portion of a first embodiment can be combined with a portion of a second embodiment, or a portion of a first embodiment can be combined with a portion of a second embodiment and a portion of a third embodiment.

The embodiments illustrated and discussed in relation to the figures included herein are provided for the purpose of explaining some of the basic principles of the disclosure. However, the scope of this disclosure covers all related, potential, and/or possible, embodiments, even those differing from the idealized and/or illustrative examples presented. This disclosure covers even those embodiments which incorporate and/or utilize modern, future, and/or as of the time of this writing unknown, components, devices, systems, etc., as replacements for the functionally equivalent, analogous, and/or similar, components, devices, systems, etc., used in the embodiments illustrated and/or discussed herein for the purpose of explanation, illustration, and example.

The following detailed description is merely illustrative in nature and is not intended to limit the embodiments or the application and uses of such embodiments. As used herein, the word “exemplary” means “serving as an example, instance, or illustration.” Any implementation described herein as exemplary is not necessarily preferred or advantageous over other implementations. Furthermore, there is no intention to be bound by any expressed or implied theory presented in the preceding technical field, background, brief summary or the following detailed description.

References to “one embodiment” or “an embodiment.” do not necessarily refer to the same embodiment. Particular features, structures, or characteristics can be combined in any suitable manner consistent with this disclosure.

Terminology. The following paragraphs provide definitions and/or context for terms found in this disclosure (including the appended claims):
“Comprising” is open-ended term does not foreclose additional structure or steps.
“Configured to” connotes structure by indicating that a device, such as a unit or a component, includes structure that performs a task or tasks during operation, such structure is configured to perform the task even when the device is not currently operational (e.g., is not on/active). A device “configured to” perform one or more tasks is expressly intended to not invoke a means or step plus function interpretations under 35 U.S.C. § 112, (f) or sixth paragraph.
“First,” “second,” etc. terms are used as labels for nouns that they precede, and do not imply any type of ordering (e.g., spatial, temporal, logical, etc.). For example, reference to a “first” solar cell does not necessarily mean such solar cell in a sequence; instead, the term “first” is used to differentiate this solar cell from another solar cell (e.g., a “second” solar cell).
“Coupled” refers to elements, features, structures or nodes unless expressly stated otherwise, that are or can be directly or indirectly joined or in communication with another element/node/feature, and not necessarily directly mechanically joined together.
“Inhibit” describes reducing, lessening, minimizing or effectively or actually eliminating something, such as completely preventing a result, outcome or future state completely.
“Doped regions,” “semiconductor regions,” and similar terms describe regions of a semiconductor disposed in, on, above or over a substrate. Such regions can have a N-type conductivity or a P-type conductivity, and doping concentrations can vary. Such regions can refer to a plurality of regions, such as first doped regions, second doped regions, first semiconductor regions, second semiconductor regions, etc. The regions can be formed of a polycrystalline silicon on a substrate or as portions of the substrate itself.
“Thin dielectric layer,” “tunneling dielectric layer,” “dielectric layer,” “thin dielectric material” or intervening layer/material refers to a material on a semiconductor region, between a substrate and another semiconductor layer, or between doped or semiconductor regions on or in a substrate. In an embodiment, the thin dielectric layer can be a tunneling oxide or nitride layer of a thickness of approximately 2 nanometers or less. The thin dielectric layer can be referred to as a very thin dielectric layer, through which electrical conduction can be achieved. The conduction can be due to quantum tunneling and/or the presence of small regions of direct physical connection through thin spots in the dielectric layer. Exemplary materials include silicon oxide, silicon dioxide, silicon nitride, and other dielectric materials.
“Intervening layer” or “insulating layer” describes a layer that provides for electrical insulation, passivation, and inhibit light reflectivity. An intervening layer can be several layers, for example a stack of intervening layers. In some contexts, the insulating layer can be interchanged with a tunneling dielectric layer, while in others the insulating layer is a masking layer or an “antireflective coating layer” (ARC layer). Exemplary materials include silicon nitride, silicon oxynitride, silicon dioxide, aluminum oxide, amorphous silicon, polycrystalline silicon, molybdenum oxide, tungsten oxide, indium tin oxide, tin oxide, vanadium oxide, titanium oxide, silicon carbide and other materials. In an example, the intervening layer can include a material that can act as a moisture barrier. Also, for example, the insulating material can be a passivation layer for a solar cell.
“Substrate” can refer to, but is not limited to, semiconductor substrates, such as silicon, and specifically such as single crystalline silicon substrates, multi-crystalline silicon substrates, wafers, silicon wafers and other semiconductor substrates used for solar cells. In an example, such substrates can be used in micro-electronic devices, photovoltaic cells or solar cells, diodes, photo-diodes, printed circuit boards, and other devices. These terms are used interchangeably herein.
“About” or “approximately”. As used herein, the terms “about” or “approximately” in reference to a recited numeric value, including for example, whole numbers, fractions, and/or percentages, generally indicates that the recited numeric value encompasses a range of numerical values (e.g., +/−5% to +/−10% of the recited value) that one of ordinary skill in the art would consider equivalent to the recited value (e.g., performing substantially the same function, acting in substantially the same way, and/or having substantially the same result).

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import.

Disclosed herein are solar cells. In one embodiment, a substrate may include a back surface and an opposing light-receiving surface. A plurality of semiconductor regions is disposed in or above the back surface of the substrate. A conductive contact structure is disposed on the semiconductor regions. The conductive contact structure includes a plurality of conductive wires, each conductive wire of the plurality of conductive wires essentially continuously bonded directly to a corresponding one of semiconductor regions. In an additional embodiment, each conductive wire of the plurality of conductive wires can be bonded through a metal layer to one of the semiconductor regions. In an example, the metal layer can be a metal seed layer. In an embodiment, each conductive wire of the plurality of conductive wires can be a non-coated conductive wire. In one example, the conductive contact structure can include a non-coated conductive wire or a plurality of non-coated conductive wires.

Also, disclosed herein are strings of solar cells. In one embodiment, a string of solar cells includes a plurality of solar cells, such as back-contact solar cells or front contact solar cells. Each of the plurality of back-contact solar cells includes P-type and N-type doped diffusion regions. A plurality of conductive wires is disposed over a back surface of each of the plurality of solar cells, wherein each of the plurality of wires is substantially parallel to the P-type and N-type doped diffusion regions of each of the plurality of solar cells. Every other one of the plurality of wires is cut in a region between each adjacent pair of the plurality of solar cells.

Also disclosed herein are methods of fabricating strings of solar cells. In one embodiment a method of electrically coupling solar cells involves aligning conductive wires over the back sides of adjacent solar cells. The wires are aligned substantially parallel to P-type and N-type doped diffusion regions of the solar cells. The method involves bonding the wires directly to the back side of each of the solar cells over the P-type and N-type doped diffusion regions using thermocompression bonding, ultrasonic bonding, or thermosonic bonding.

Also disclosed herein are wire bonding systems for electrically coupling solar cells. In one embodiment, a wire bonding system includes one or more of a creel assembly containing a plurality of wire spools, a coarse pitch assembly with a plurality of coarse pitch combs, a fine pitch comb, a feed roller, and a compression roller. Various capstans, rollers, and/or the like may be provided within the wire bonding system to control tension of wires that are fed through the wire bonding system. In an embodiment, one or both of the feed roller or the compression roller may comprise grooves that are configured to align conductive wires substantially parallel with P-type and N-type doped diffusion regions of each of the solar cells in order to bond the wires to the back side of each of the solar cells over the P-type and N-type doped diffusion regions.

Thus, one or more embodiments described herein are directed to metallization and stringing techniques. According to embodiments, wires can be used to string back-contact solar cells together instead of patterned cell interconnects. The wires can also serve as metallization to collect current across the cells, either by themselves, or in conjunction with a first level metallization on the solar cells.

According to embodiments, instead of using busbars to collect the current throughout each cell, each finger (e.g., P-type doped diffusion regions or N-type doped diffusion regions) of one cell is directly connected to the corresponding finger (e.g., a finger of opposite polarity) of the next cell using continuous conductive wires. The wires are first attached across some or all cells of the entire string (e.g., in a continuous string), shorting each pair of solar cells. Every other wire is subsequently cut between cells in order to restore separate P and N electrodes. For example, P and N electrodes are separate but connected back and forth if every other wire is not cut. Every other wire connects the P electrodes of a first cell to the N electrodes of a second cell. The other wires connect the N electrodes of the first cell to the P electrodes of the second cell. The pair of cells is therefore shorted if one of the two sets of wires is not cut. Therefore, cutting one of the two sets of wires between a given pair of cells can restore separate P and N electrodes.

It is to be appreciated that improvements in metallization methods for forming conductive contacts of solar cells are generally desirable. In contrast to some metallization methods, e.g., plating conductive contacts on a solar cell, other techniques can include bonding conductive foil and/or conductive wires to a semiconductor substrate (e.g., a silicon substrate). Such methods can require loading and reloading a substantial number of wires into a bonding tool, which can be particularly challenging to setup and process. Techniques described herein provide for approaches and apparatuses to place, align and bond conductive wires and to a semiconductor substrate in a solar cell metallization and/or stringing process. Various examples are provided throughout.

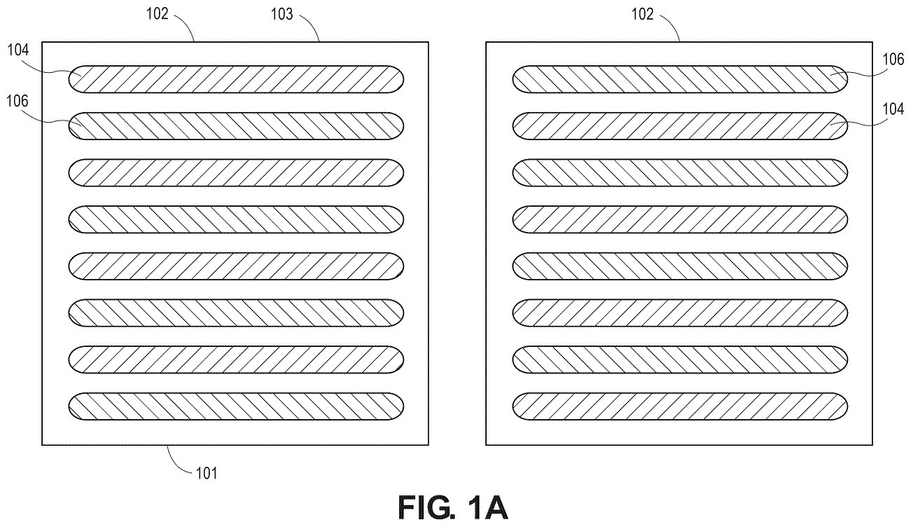

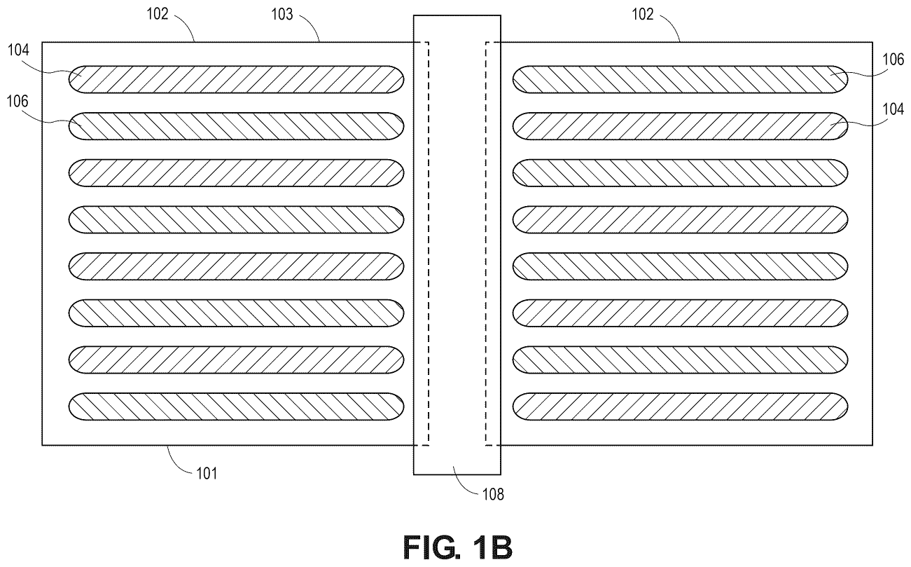

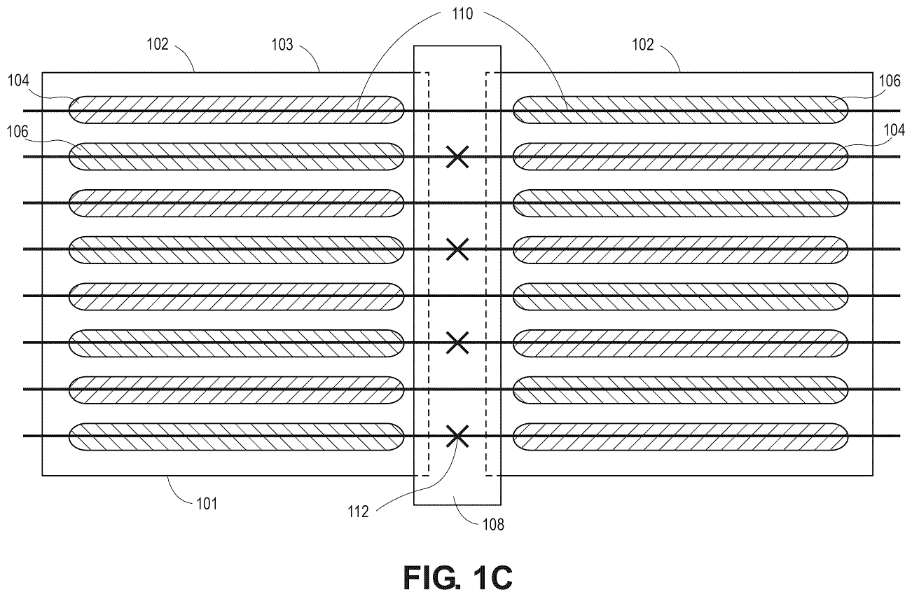

FIGS. 1A-1C illustrate plan views of various stages in a metallization and stringing method for back-contact solar cells, in accordance with an embodiment of the present disclosure.

FIG. 1A illustrates a back-side view of adjacent solar cells 102 that are to be stringed together, including alternating P-type doped diffusion regions 104 and N-type doped diffusion regions 106. In one such embodiment, each of the plurality of solar cells 102 is substantially rectangular, and the P-type doped diffusion regions 104 and the N-type doped diffusion regions 106 are substantially parallel to the edges 101, 103 of the solar cells 102. A solar cell that is substantially rectangular could be, for example, a square, or another rectangular shape, and can have standard, cut, or rounded corners. As illustrated in FIG. 1A, the solar cells 102 are asymmetric in the sense that the solar cells 102 end with a P finger on one side (e.g., side 103) and an N finger on the opposite side (e.g., side 101). The asymmetric solar cells can then be placed in alternating orientations along the string, as illustrated in FIG. 1A. The asymmetric solar cell design together with the alternating orientations along the string enable the use of wires that are parallel to the edges 101, 103 of the solar cells because the P finger on one of the solar cells is directly across from the N finger of the adjacent solar cell, as is explained below with respect to FIG. 1C.

Referring to FIG. 1B, a method of metallization and stringing includes attaching a non-conductive shield, tape or paint strip 108 to the back sides of the adjacent solar cells 102. The non-conductive shield, tape or paint strip 108 can serve to hide the wires when viewed from the front. In some embodiments, non-conductive shield, tape or paint strip 108 is applied to the adjacent solar cells 102 before the conductive wires 110 are applied. In other embodiments, the conductive wires are bonded to the adjacent solar cells 102 so that the conductive wires 110 are not bonded up to edges of the solar cells 102. In such an embodiment, the non-conductive shield, tape or paint strip 108 is then inserted between the back of the solar cells 102 and the conductive wires 110. In yet another embodiment, the non-conductive shield, tape or paint strip 108 may be placed on the sunny side (i.e., the top side of the adjacent solar cells 102). Thus, the non-conductive shield covers exposed sections of the wires between each adjacent pair of the plurality of solar cells. Therefore, according to embodiments, the non-conductive shield, tape or paint strip 108 includes a material that is substantially opaque to sufficiently cloak the wires when viewed from the front. The non-conductive shield, tape or paint strip 108 can also assist in alignment of the solar cells, and/or holding the solar cells 102 together. The non-conductive shield, tape or paint strip 108 can include materials such as polypropylene or polyethylene and can further include an adhesive layer like an acrylate. A non-conductive shield, tape or paint strip 108 with an adhesive layer can be beneficial to assist in alignment. Although a non-conductive shield, tape or paint strip 108 can be beneficial for the reasons explained above, other embodiments do not include a non-conductive shield (e.g., the non-conductive shield 108 can be optional).

Referring to FIG. 1C, the method of metallization and stringing includes aligning conductive wires 110 over the back sides of adjacent solar cells 102. As shown in FIG. 1C, the non-conductive shield, tape or paint strip 108 is present during the conductive wire 110 bonding. In other embodiments, the non-conductive shield, tape or paint strip 108 may be applied after the conductive wires 110 are bonded to the solar cells 102. In one embodiment, the wires 110 are aligned substantially parallel to the P-type doped diffusion regions 104 and N-type doped diffusion regions 106 of the solar cells 102. The wires 110 can have a cross-sectional shape that is round, flattened, slightly flattened, or another shape. Round wires can be beneficial because they can be rolled or twisted. In an embodiment involving the alignment and placement of round wires, the wires can be flattened prior to or during bonding the wires to the back side of each of the solar cells.

Conductive wires include an electrically conducting material (e.g., a metal such as aluminum, copper or another suitable conductive material), with or without a coating such as tin, silver, or nickel. In an embodiment, an organic solderability protectant is not used on the wires. In another embodiment, an organic solderability protectant is used on the wires. In the embodiment illustrated in FIG. 1C, the number of wires is equal to (or substantially equal to) the number of diffusion regions of each of the plurality of solar cells. In one example, the number of wires can be approximately between 5-15 wires, between 10-20 wires, between 15-25 wires, between 20-30 wires, between 25-35 wires, between 30-40 wires, between 35-45 wires, between 10-50 wires, or greater than 50 wires. In one such embodiment, a single wire is aligned over each of the P-type doped diffusion regions 104 and N-type doped diffusion regions 106 of the solar cells 102. According to one embodiment, each of the wires 110 is roughly centered over one of the P-type doped diffusion regions 104 and N-type doped diffusion regions 106 of the solar cells 102. As illustrated in FIG. 1C, the wires 110 can be aligned so that they are substantially parallel to the edges 101, 103 of the plurality of solar cells 102.

Referring again to FIG. 1C, the wires 110 can be aligned via a variety of mechanisms. For example, in one embodiment, aligning the conductive wires 110 over the back sides of adjacent solar cells 102 involves use of a grooved roller or a bond head. Other mechanisms can be used to align the conductive wires 110 over the P-type doped diffusion regions 104 and N-type doped diffusion regions 106 of the solar cells 102 instead of, or in addition to, a grooved roller or a bond head. For example, according to one embodiment, a reed, or other mechanism suitable for aligning and guiding the conductive wires can be used. When aligning wires over a solar cell that is not the first solar cell, the presence of wires bonded to the first solar cell can assist in alignment of the wires over the subsequent solar cells, in accordance with an embodiment.

After aligning the conductive wires 110, the conductive wires are bonded to the back side of the solar cells 102 the P-type doped diffusion regions 104 and N-type doped diffusion regions 106 of the solar cells 102, e.g., using thermocompression bonding or ultrasonic bonding approaches as described herein. Referring again to FIG. 1C, according to one embodiment, the method of metallization and stringing includes cutting every other one of the wires 110 between each adjacent pair of the solar cells 102. As illustrated in FIG. 1C, the wires 110 are cut at the locations 112, such that all of the wires connected to the P-type diffusion on one side of a solar cell 102, and all of the wires connected to the N-type diffusion of the opposite side of the solar cell are cut.

Prior to cutting the wires 110 in the locations 112, the pair of solar cells are shorted. Cutting the wires 110 enables electrically coupling the solar cells for collection of current from the solar cell string. Cutting the wires 110 in the locations 112 can involve any wire cutting technique. For example, the wires 110 can be cut in the locations 112 with a laser or a blade. Although the FIGS. 1A-1C illustrate only two solar cells, a solar cell string can include any number of solar cells stringed together (e.g., 2 or more solar cells stringed together). The process is continuous in the sense that arbitrarily long strings of solar cells can be made.

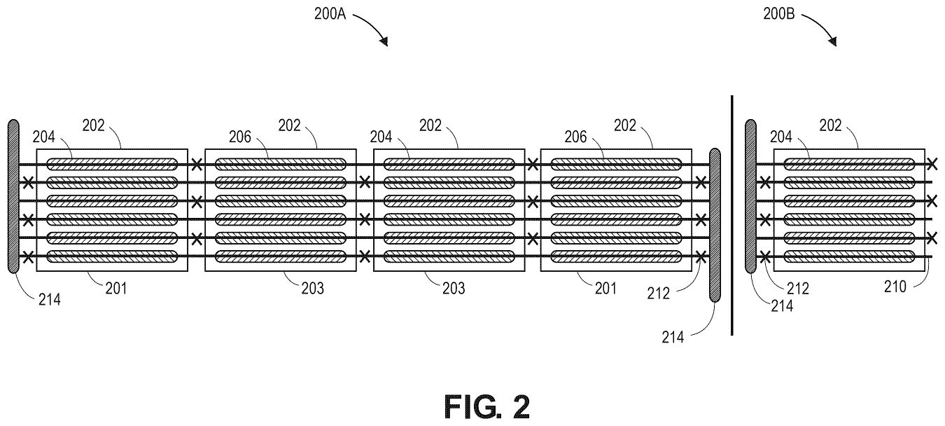

FIG. 2 illustrates one example of a string of solar cells, in accordance with an embodiment of the present disclosure. The solar cell string 200A illustrated in FIG. 2 includes a plurality of solar cells 202 that are electrically coupled together in series. The solar cell string 200A has two end solar cells 201, and inner solar cells 203 connected in series between the two end solar cells 201. Each of the two end solar cells 201 is electrically coupled with a busbar 214. At each of the end solar cells 201, every other one of the wires is coupled with a busbar 214 to couple only one of the two electrodes of the end solar cell, either the P-type doped diffusion regions 204 or the N-type doped diffusion regions 206. In one embodiment, the coupling of every other one of the wires from an end solar cell 201 with a busbar 214 can be achieved by first cutting all the wire at each end of the string and connecting only the wires for either the P-type or N-type doped diffusion regions. Alternatively, all the wires for an end solar cell 201 can first be connected to a busbar 214, and then every other wire can be cut in the locations 212.

Only the end solar cells 201 are connected to a busbar 214, in contrast to other stringing techniques which can involve attaching busbar(s) to each solar cell, according to some embodiments. Though, embodiments may also include busbars 214 between each solar cell 201 as well. The busbars 214 can couple the solar string 200A with another solar string (e.g., such as the solar string 200B), or to another circuit (e.g., a circuit outside the module through a junction box).

As illustrated in FIG. 2, in one embodiment, a given cut section of wire is to electrically couple at most two solar cells together in series, wherein the P-type doped diffusion area of one of the two solar cells is connected to the N-type doped diffusion area of the other solar cell. However, other embodiments can include more than two solar cells being coupled together with a given cut section of wire. For example, if solar cells are connected in parallel, it is possible to connect more than two cells with a given cut section of wire. Also as illustrated in FIG. 2, in one embodiment, a cut section of wire that electrically couples an end solar cell 201 to the busbar 214 couples a single solar cell to the busbar 214. However, as mentioned above, in embodiments that connect solar cells in parallel, a given cut section of wire can connect more than a single solar cell to the busbar. Thus, a solar string can be created using the plurality of wires 210 by aligning and bonding the wires over the P-type and N-type doped diffusion regions of each of the solar cells, followed by cutting some of the wires to achieve the desired configuration of solar cells in a string.

Thus, in accordance with one or more embodiments of the present disclosure, a stringing method provides a structure having compressed wires against one or more solar cells. In an embodiment, every second wire is cut between wafers and busbars at ends.

As can be appreciated, aligning and bonding the number of wires to the proper diffusion regions in a high-volume assembly environment is a complex task. Accordingly, embodiments disclosed herein include a wire feed and bonding system 300. The wire feed and bonding system 300 allows for a plurality of wires 315 to be fed from a plurality of spools 312 to specified grooves on a compression roller 342. The grooves on the compression roller 342 are configured to be aligned with different diffusion regions on a solar cell. A plurality of solar cells may pass below the compression roller 342 (e.g., on a conveyor and/or track based system), and the wires 315 are bonded to each solar cell as the solar cells pass below the compression roller 342. In some embodiments, the wires 315 are bonded to diffusion regions of each solar cell, to poly-silicon regions of each solar cell, or any other desired location along the solar cell.

Due to their size, the spools 312 may have relatively large spacings, and the spools 312 may be stacked vertically and/or horizontally in a creel assembly 310. In some embodiments, a pitch between wires at a course pitch comb 322 may be between approximately 2.0 mm and approximately 20 mm. Though, smaller or larger pitches for the wires at the course pitch comb 322 may also be possible. A plurality of creel assemblies 310 may also be used in some embodiments. A number of spools 312 may be equal to a number of grooves on the compression roller 342. As such, the distance between wires 315 needs to be reduced from a first wide pitch to a final narrow pitch by the wire feed and bonding system 300. The wire feed and bonding system 300 may also translate the wires from multiple different horizontal planes to a single horizontal plane.

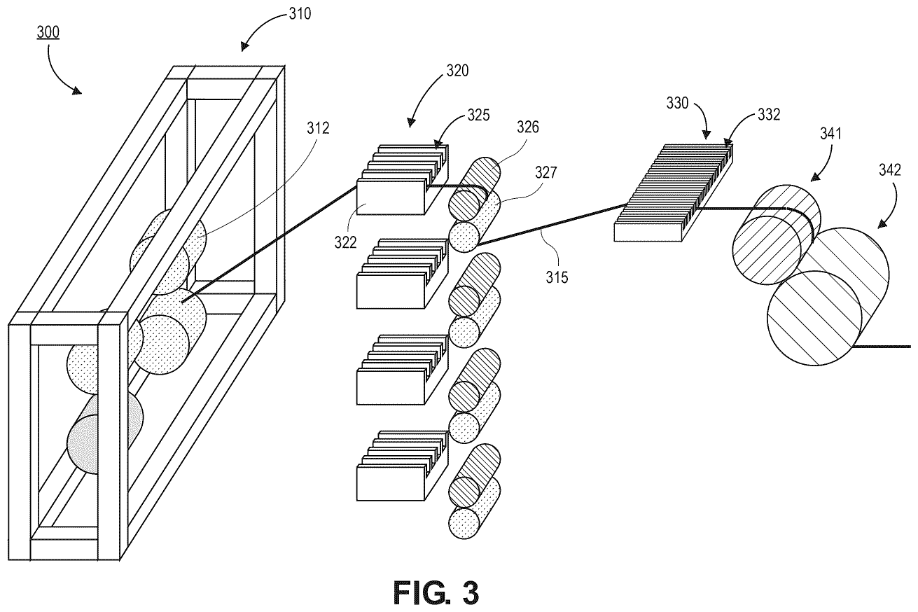

As shown in FIG. 3, a creel assembly 310 comprises a plurality of spools 312. While four spools 312 are shown in creel assembly 310, the creel assembly 310 may comprise a single spool 312, or two or more spools 312. For example, the creel assembly 310 may comprise four or more spools 312, ten or more spools 312, or twenty or more spools. The spools 312 may be arranged in a plurality of rows and/or a plurality of columns within the creel assembly 310. Further, while a single creel assembly 310 is shown in FIG. 3, embodiments may include a plurality of creel assemblies 310 in the wire feed and bonding system 300.

In an embodiment, each spool 312 may comprise a length of wire 315 that is wound around the spool 312. A single wire 315 from one of the spools 312 is shown as an example so as to not overcomplicate FIG. 3 and obscure aspects of certain embodiments. The wire 315 may comprise any electrically conductive material that is suitable for being wire bonded to solar cells. One or more embodiments described herein may include an aluminum wire. It is to be appreciated that, in some embodiments, aluminum wires 315 are preferred since they can be subjected to thermocompression bonding at a temperature in a range of approximately 300-450 degrees Celsius, or lower with the inclusion of ultrasonic energy. In a particular example, the bonding temperature can include approximately 350 degrees Celsius. By contrast, a copper wire may need to be heated to substantially higher temperatures for thermocompression bonding and, as a result, can cause a silicon substrate to bow upon cooling after bonding to the silicon substrate. It is also to be appreciated that excessive bowing with copper wires can result from the fact that copper has a higher yield strength than pure aluminum. On cooling, both aluminum and copper will contract to drive wafer bowing, but the degree of contraction in aluminum is limited by the low yield strength. Many aluminum alloys have higher yield strength (e.g., 241 MPA for AL6061) while pure aluminum has a yield strength of 11 MPA. Accordingly, in some embodiments, pure or essentially pure aluminum wires are used for forming a metallization layer for silicon based solar cells to enable low bowing. Additionally, the lower yield strength allows for lower forces to plastically deform the wire, which is beneficial for thermocompression bonding. In an example, the aluminum wires do not include any additional coating or layer. Copper may also form thick oxides in air at the high temperatures required for thermocompression bonding, whereas an oxide of aluminum is self-limiting. However, in other embodiments, copper wires or any other wire material described herein (with or without a coating) may be used for forming a metallization layer for solar cells with the wire feed and bonding system 300.

In an embodiment, the spools 312 may be passively spun to unreel the wire 315. That is, a force that pulls the wire 315 out from the spool 312 may result in the spool 312 spinning. In other embodiments, the spools 312 may be actively controlled (e.g., with a motor or the like) in order to assist in the wire feed process. For example, an actively controlled spool 312 may be used to help control tension along the wire 315 during the wire feed process.

In an embodiment, the spools 312 may feed wires 315 to a coarse pitch assembly 320. The coarse pitch assembly may comprise a plurality of coarse pitch combs 322. In the illustrated embodiment, the coarse pitch combs 322 are oriented in a vertical stack. Though, the coarse pitch combs 322 may be provided with any spatial positioning. The coarse pitch assembly 320 in FIG. 3 comprises four coarse pitch combs 322. Though, in other embodiments one or more coarse pitch combs 322 may be used. For example, the coarse pitch assembly 320 may comprise two or more coarse pitch combs 322, four or more coarse pitch combs, or ten or more coarse pitch combs 322.

In an embodiment, each of the coarse pitch combs 322 may define a plurality of channels 325 or slots. In FIG. 3, the channels 325 are defined by a plurality of substantially parallel fins. Though, as will be described in greater detail herein, the channels 325 may be defined by a plurality of pins or the like. In an embodiment, a pitch of the channels 325 may be an integer multiple of the desired final pitch. In a particular embodiment, the integer multiple is equal to the number of coarse pitch combs 322 provided in the coarse pitch assembly 320. For example, in FIG. 3 the pitch of the channels 325 may be approximately four times the desired final pitch of the wires 315. In a particular embodiment, the pitch of the channels 325 may be between approximately 1 mm and approximately 5.0 mm. For example, the pitch of the channels 325 may be approximately 2.0 mm. Though, it is to be appreciated that smaller or larger pitches may also be used for the channels 325 in other embodiments.

In an embodiment, the wires 315 may be routed from the coarse pitch combs 322 to a single fine pitch comb 330. The fine pitch comb 330 may align the wires 315 into a single horizontal plane. The fine pitch comb 330 may have a plurality of channels 332 that are spaced at a fine pitch that is smaller than the coarse pitch. In an embodiment, the fine pitch is substantially equal to the pitch of grooves on the compression roller 342. For example, the fine pitch may be between 0.1 mm and 1.0 mm. In the case of a coarse pitch of approximately 2.0 mm with four coarse pitch combs 322, the fine pitch may be approximately 0.5 mm.

In an embodiment, the wires 315 may at least partially wrap around one or more rollers between the coarse pitch assembly 320 and the fine pitch comb 330. For example, each wire 315 may pass through a driven capstan roller 326 and an idle roller 327. The driven capstan roller 326 may be driven by a motor or the like. The idle roller 327 may spin passively as wire 315 is drawn through the system. The driven capstan roller 326 allows for the tension in the wire 315 to be decreased before reaching the fine pitch comb 330. That is, the tension in the wires 315 between the creel assembly 310 and the coarse pitch assembly 320 may be higher than a tension in the wires 315 between the coarse pitch assembly 320 and the fine pitch comb 330. While a roller assembly with two rollers (e.g., driven capstan roller 326 and idle roller 327) is shown, embodiments may include one or more rollers, or rollers may be omitted from the system 300.

In an embodiment, the wires 315 may be routed from the coarse pitch assembly 320 to the fine pitch comb 330 through the use of transfer caps (not shown in FIG. 3). Each transfer cap may have slots that receive the ends of each wire 315 of a given coarse pitch comb 322, and the transfer cap delivers the wires 315 to the fine pitch comb 330. Each of the transfer caps are offset from each other by one fine pitch. This allows for the wires 315 from all of the coarse pitch combs 322 to be interleaved with each other at the fine pitch comb 330 in an orderly manner. A more detailed description of the transfer caps and a process for using the transfer caps is described in greater detail below.

In an embodiment, the wires 315 may exit the fine pitch comb 330 and at least partially wrap around a feed roller 341. In an embodiment, grooves (not visible in FIG. 3) are provided on a surface of the feed roller 341. The grooves may be formed with a pitch that matches a pitch of grooves (not visible) on the compression roller 342. In some embodiments, the exact pitch of the grooves on the feed roller 341 and the compression roller 342 may differ when the wire feed and bonding system 300 is not operating. Such a difference in the pitch may be used to account for different amounts of thermal expansion between the feed roller 341 and the compression roller 342 when both are at their respective operating temperature. For example, the feed roller 341 and the compression roller may be heated to different temperatures to assist in heating the wires to the required temperature for a thermocompression bond to the solar cells.

In an embodiment, the grooves on the feed roller 341 may be deeper than a radius of the wires 315 so that the wires 315 are held within the grooves. A retaining member (not shown) may also be placed immediately adjacent to the feed roller 341. The retaining member (e.g., a curved plate, an additional roller, or the like) may cover the wires 315 when in the grooves of the feed roller 341 to further constrain the wires 315 to the feed roller 341 grooves. A movable comb (not shown) with the same pitch as the feed roller 341 may also be used to maintain consistent spacing between wires 315 as the wires 315 are wound around the feed roller 341. The moveable comb may be initially placed adjacent to the fine pitch comb 330 containing the wires 315 and moved parallel to the fins of the fine pitch comb 330 that define the plurality of channels 332 such that the wires 315 are loaded into the moveable comb. The moveable comb may then be moved adjacent to the feed roller 341 (or compression roller 342 if a feed roller 341 is not used) such that the spacing of the wires 315 is maintained and each wire 315 in the web may be seated in a unique groove on the feed roller 341 (or compression roller 342).

Alternatively, wires 315 may be guided onto the feed roller 341 or compression roller 342 with a fixed aligner component (not shown) that comprises a linear array of holes. In an embodiment, the hole diameter is slightly larger than the wire 315 diameter. Each wire 315 may be threaded through an individual hole in the aligner, and the pitch of the array of holes is matched to the pitch of the grooves on the feed roller 341 or compression roller 342. The distance between the exit point of the hole and the surface of the feed roller 341 or compression roller 342 is minimized such that each wire 315 is guided onto a unique groove on the feed roller 341 or compression roller 342.

If a feed roller 341 is used to guide wire onto the compression roller 342, the gap between the feed roller 341 and the compression roller 342 may be minimized to ensure that each wire 315 is guided from a unique groove on the feed roller 341 to the matched unique groove on the compression roller 342.

In an embodiment, the feed roller 341 may be driven by a motor to assist in reducing the tension of the wires 315 before they are wrapped around the compression roller 342. Reducing the tension of the wires 315 may be beneficial since the compression roller 342 may be at a high temperature to implement the thermocompression bonding process. The high temperature reduces the tensile strength of the wires 315, which may lead to an increased risk of breaking wires 315 if the tension is not first reduced by the feed roller 341, which may be at a lower temperature. Conversely, if the wires 315 are delivered to the feed roller 341 at a low tension, the feed roller 341 may be driven in such a way to increase the tension of the wires 315 so that wires 315 are pulled into the grooves on the compression roller 342. The motor driving the feed roller 341 may be driven in such a way such that the surface velocity of the feed roller 341 and the surface velocity of the compression roller 342 are closely matched, or the feed roller 341 may be driven slightly slower than the compression roller 342 to increase tension in the wires 315. The feed roller 341 may also be driven by controlling the torque applied to the driving motor, which acts to control the tension in the wires 315.

In some embodiments, a clamping mechanism (not shown) may be used to hold the wires 315 in place after the wires 315 have been wrapped around the compression roller 342. Such a clamping mechanism may be used to maintain tension on the wires 315 and retain the wires 315 in the compression roller 342 grooves between bonding operations. The clamp may grip the entire width of a wire 315 web. That is, the clamp may grip each of the wires 315 that are passed through the compression bonding system. In some embodiments, the clamp may be moveable away from the compression roller 342 to take up any slack in the wire 315 web that may have developed while the system 300 is idle.

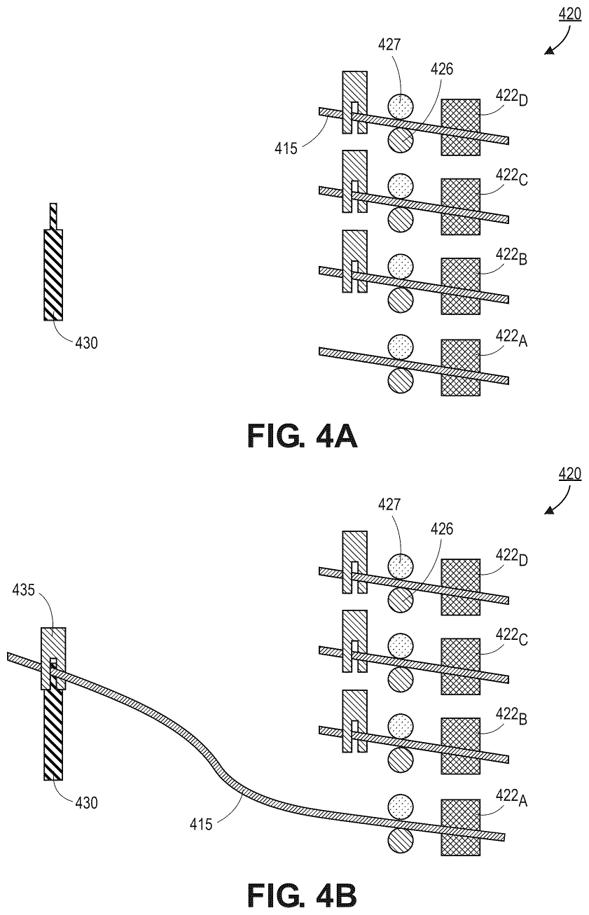

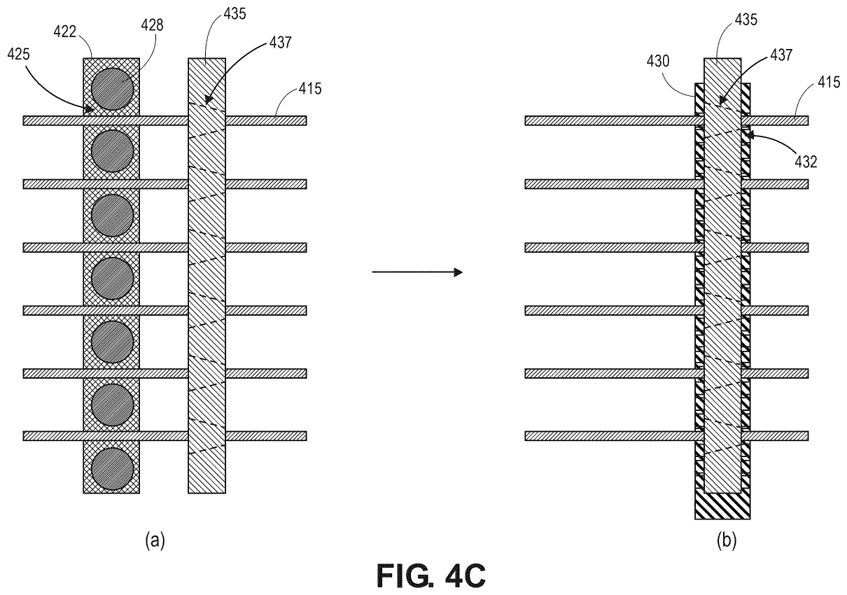

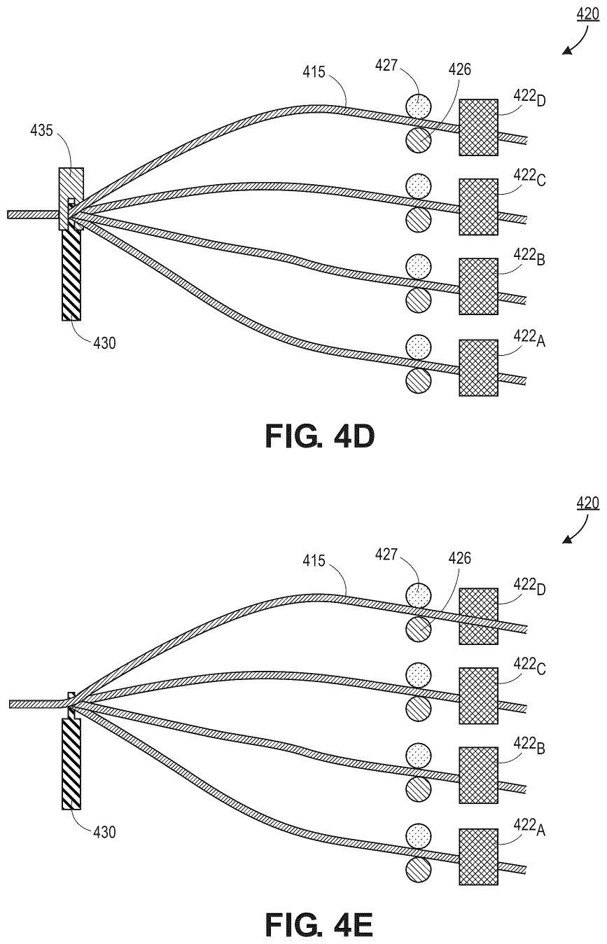

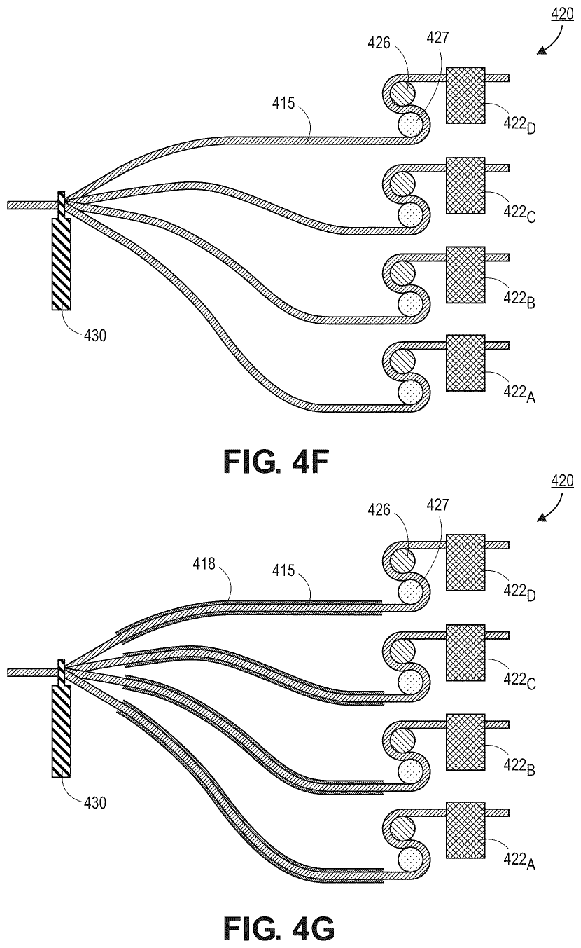

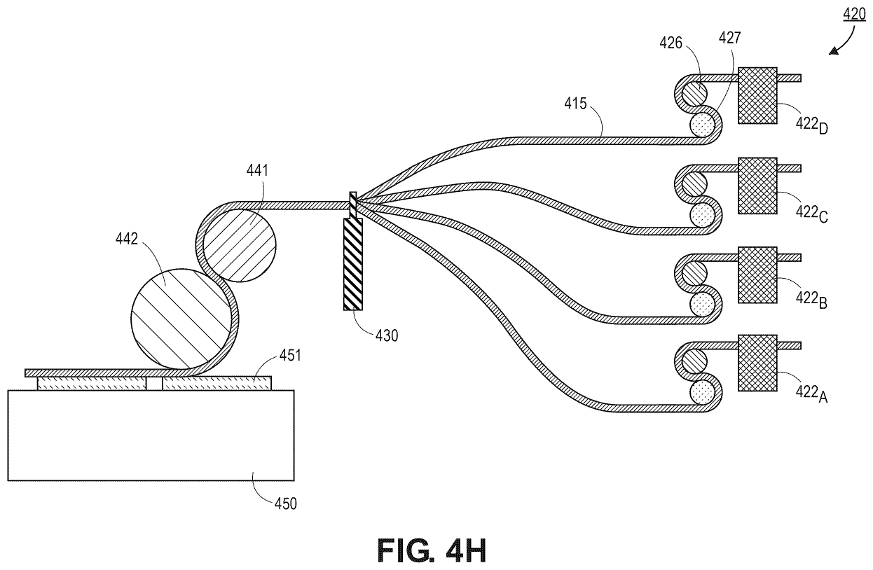

Referring now to FIGS. 4A-4H , a series of illustrations depicting a process for routing wires 415 through the wire feed system for the compression bonding is shown, in accordance with an embodiment. In an embodiment, the wire feed and bonding system shown in FIGS. 4A-4H may be similar to the wire feed and bonding system 300 described with respect to FIG. 3.

FIG. 4A shows a cross-sectional illustration of a coarse pitch assembly 420 and a fine pitch comb 430, in accordance with an embodiment. As shown, the coarse pitch assembly 420 comprises a plurality of coarse pitch combs 422. For example, a vertical stack of four coarse pitch combs 422_{A}-422_{D} is shown in FIG. 4A. In an embodiment, wires 415 pass through each of the coarse pitch combs 422. The wires 415 may pass between a driven capstan roller 426 and an idle roller 427. Though, at this point the wire 415 may not be engaged (e.g., wrapped around) either of the rollers 426 or 427.

In an embodiment, a transfer cap 435 is provided for each of the coarse pitch combs 422. The transfer caps 435 may engage the wires 415 that pass through each of the coarse pitch combs 422. In an embodiment, the transfer caps 435 may comprise a plurality of channels to secure each of the wires 415 so that the transfer caps 435 can guide the wires 415 towards the fine pitch comb 430 and insert the wires 415 into the fine pitch comb 430. FIG. 4B shows a first transfer cap 435 after the transfer cap 435 has guided wires 415 from a first coarse pitch comb 422_{A} to the fine pitch comb 430.

Referring now to FIG. 4C, a plan view illustration of the transfer of wires 415 from the coarse pitch comb 422 to the fine pitch comb 430 by the transfer cap 435 is shown, in accordance with an embodiment. The transfer cap 435 may comprise a plurality of narrow slots 437 at the coarse pitch (e.g., one slot 437 for each wire 415 in the coarse pitch comb 422). The wires 415 may be loaded into the transfer cap 435 (as shown in the (a) portion of FIG. 4C). Thereafter, the transfer cap 435 is aligned to the fine pitch comb 430. The wires 415 may then be transferred out of the transfer cap 435 and into corresponding slots 432 in the fine pitch comb 430. As shown in the (b) portion of FIG. 4C, the transfer cap 435 may fit over the top of (or substantially adjacent) to the fine pitch comb 430 and precisely guides the wires 415 from the coarse pitch comb 422 into the correct slot 432 in the fine pitch comb 430.

In an embodiment, each coarse pitch comb 422 has its own transfer cap 435. In an embodiment, the slots 437 in each transfer cap 435 may be offset by one fine pitch. Accordingly, when all wires 415 from the plurality of coarse pitch combs 422 are loaded into the fine pitch comb 430, there is one wire 415 in each slot 432 of the fine pitch comb 430. For example, in the (b) portion of FIG. 4C, each wire 415 is placed in every fourth slot 432.

In an embodiment, the coarse pitch comb 422, the fine pitch comb 430, and/or the transfer cap 435 may comprise smooth edges so that the wires 415 may pass through them freely. For example, the slots 425 of the course pitch combs 422 may be defined by round pins 428. The round pins 428 may have a diameter that is close to the coarse pitch so that gaps between the round pins 428 are only slightly larger than the diameter of the wires 415. This simplifies locating the wires 415 within a narrow range of possible locations which enables the wires 415 to align well with the narrow slots 437 of the transfer cap 435. Additionally, some embodiments may include slots 437 in the transfer cap 435 that have a wider opening facing the coarse pitch comb 422 to enable the wires 415 to pass more easily in each slot 437. The opposite opening of the slots 437 that faces the fine pitch comb 430 may be narrower to provide better alignment with the fine pitch slots 432 of the fine pitch comb 430. That is, some embodiments may refer to the slots 437 as being tapered. Though, it is to be appreciated that the slots 437 may also have a uniform width along their length in other embodiments.

Referring now to FIG. 4D, a cross-sectional illustration of the system after the last transfer cap 435 has inserted wires 415 from the fourth coarse pitch comb 422_{D} into the fine pitch comb 430 is shown, in accordance with an embodiment. FIG. 4E shows the system after the last transfer cap 435 is removed.

Referring now to FIG. 4F, a cross-sectional illustration of the system after the rollers 426 and 427 are engaged with the wires 415 is shown, in accordance with an embodiment. In an embodiment, the rollers 426 and 427 may be rotated so that the wires 415 at least partially wrap around each of the rollers 426 and 427. For example, the wires 415 may first wrap around a portion of the driven capstan roller 427 and then wrap around a portion of the idle roller 427. As noted above, engaging the rollers 426 and 427 may allow for better control of tension within the wires 415 through the system. In the illustrated embodiment, each pair of rollers 426 and 427 have the same orientation. In other embodiments the pairs of rollers 426 and 427 may be individually controllable. As such, different amounts of tension control can be provided to the web of wires 415 that exit from different coarse pitch combs 422.

FIG. 4G is an illustration of a system in accordance with an additional embodiment. In an embodiment, the system in FIG. 4G may be similar to the system shown in FIG. 4F, with the exception of the wires 415 between the coarse pitch combs 422 and the fine pitch comb 430. Instead of being bare wires 415, the wires 415 in FIG. 4G pass through tubes 418. In an embodiment, low friction tubes 418 may be used to allow for the wires 415 to slide through the tubes 418 without much resistance. In an embodiment, the bend radius of the tubes 418 may be minimized to reduce additional friction. Alternatively, the bend radius of the tubes 418 may be adjusted to introduce a desired amount of tension into the wires 415. The use of wire 415 guide tubes 418 may also prevent wires 415 from tangling with each other if one or more of the wires 415 lose tension.

Referring now to FIG. 4H, a cross-sectional illustration of the system after the wires 415 are guided onto a feed roller 441 and a compression roller 442 is shown, in accordance with an embodiment. As shown, the wires 415 may partially wrap around the feed roller 441 and partially wrap around the compression roller 442. The compression roller 442 may compress the wires 415 against substrates 451, such as wafers comprising solar cells. For example, the substrates 451 may comprise solar cells similar to any of the solar cells described in greater detail herein. As a chuck 450 is displaced relative to the compression roller 442, the wires 415 are bonded across the substrates to provide an electrically connected string of solar cells, similar to any of the string of solar cells described in greater detail herein. In an embodiment, the compression roller 442 may be pressed against the substrates with a force sufficient to provide thermocompression bonding between the wires 415 and the substrates 451 at a desired temperature.

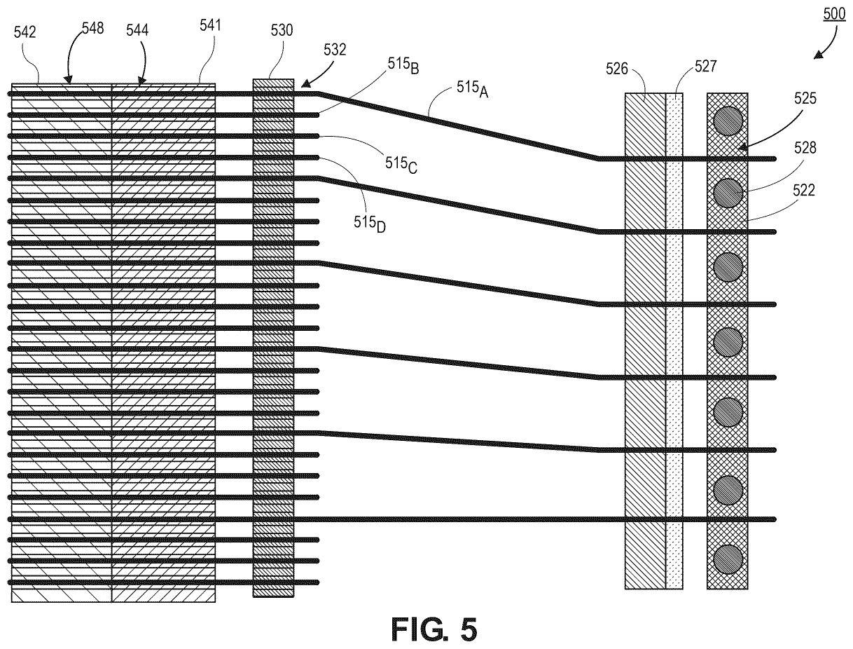

Referring now to FIG. 5, a plan view illustration of a portion of a wire feed and bonding system 500 is shown, in accordance with an embodiment. In an embodiment, the entire length of wires 515_{A} from the coarse pitch comb 522 to the compression roller 542 is shown. The remaining wires 515_{B}-515_{D} extend from the compression roller 542 to the fine pitch comb 530. Thereafter, wires 515_{B}-515_{D} extend out of the plane of FIG. 5 to coarse pitch combs 522 above or below the illustrated coarse pitch comb 522.

In an embodiment, the coarse pitch comb 522 may be similar to any of the coarse pitched combs described in greater detail herein. For example, the coarse pitch comb 522 may comprise a plurality of round pins 528 that define coarse pitch slots 525. The wires 515_{A} may then wrap through a driven capstan roller 526 and an idle roller 527 before being inserted into the slots 532 of the fine pitch comb 530. As shown, the wires 515_{A} are placed at every fourth slot 532. In an embodiment, the fine pitch comb 530 may be similar to any of the fine pitch combs described in greater detail herein.

In an embodiment, the wires 515_{A}-515_{D} may pass from the fine pitch comb 530 into grooves 544 that are formed on a surface of the feed roller 541. The grooves 544 may have a depth that is greater than the diameter of the wires 515. The wires 515 are then fed into the grooves 548 of the compression roller 542. The grooves 548 and the grooves 544 may have substantially the same pitch when the system 500 is operating and/or the feed roller 541 and the compression roller 542 are at a desired operating temperature.

In an embodiment, a wire 515 may break within the system 500 from time to time. When wire 515 breaks occur, the ends of the broken wire 515 may be re-joined together using a cold-welding tool or the like. In some embodiments, excess flashing around the weld site of the wire 515 may be removed with sandpaper or other abrasive so that a diameter of the wire 515 around the weld point remains substantially similar to the diameter of the rest of the wire 515.

In the foregoing specification, specific exemplary embodiments have been described. It will be evident that various modifications may be made thereto without departing from the scope of the following claims. The specification and drawings are, accordingly, to be regarded in an illustrative sense rather than a restrictive sense.

What is claimed is:

1. An apparatus, comprising:
a creel assembly that is configured to support a plurality of spools that each comprise an electrically conductive wire;
a plurality of coarse pitch combs, wherein the plurality of coarse pitch combs comprise first channels with a first pitch;
a fine pitch comb, wherein the fine pitch comb comprises second channels with a second pitch that is smaller than the first pitch; and
a compression roller, wherein the apparatus is configured to feed the electrically conductive wire from each of the plurality of spools in the creel assembly to the compression roller.

2. The apparatus of claim 1, wherein the plurality of coarse pitch combs are arranged in a vertical stack.

3. The apparatus of claim 1, wherein the first pitch is an integer multiple of the second pitch.

4. The apparatus of claim 3, wherein the integer multiple is equal to a number of the plurality of coarse pitch combs.

5. The apparatus of claim 1, further comprising:
a roller between the plurality of coarse pitch combs and the fine pitch comb.

6. The apparatus of claim 5, wherein the roller is a capstan roller.

7. The apparatus of claim 1, further comprising:
a feed roller between the fine pitch comb and the compression roller.

8. The apparatus of claim 7, wherein the feed roller comprises first grooves and the compression roller comprises second grooves, and wherein a third pitch of the first grooves is different than a fourth pitch of the second grooves.

9. The apparatus of claim 1, further comprising:
a transfer cap between each of the plurality of coarse pitch combs and the fine pitch comb.

10. The apparatus of claim 9, wherein the transfer cap comprises tapered grooves.

11. An apparatus, comprising:
a creel assembly that is configured to support a plurality of spools that each comprise an electrically conductive wire;
a coarse pitch assembly that comprises a plurality of coarse pitch combs, wherein each of the plurality of coarse pitch combs comprise first channels;
a fine pitch comb, wherein the fine pitch comb comprises second channels, and wherein a total number of first channels in the coarse pitch assembly is equal to a number of second channels in the fine pitch comb; and
a compression roller, wherein the apparatus is configured to feed the electrically conductive wire from each spool in the creel assembly to the compression roller, and wherein the electrically conductive wire from each creel is configured to pass through the coarse pitch assembly and the fine pitch comb before reaching the compression roller.

12. The apparatus of claim 11, wherein the compression roller comprises grooves, and wherein a first pitch of the second channels of the fine pitch comb is different than a second pitch of the grooves of the compression roller.

13. The apparatus of claim 11, wherein a first pitch of the first channels of the coarse pitch assembly is larger than a second pitch of the second channels of the fine pitch comb.

14. The apparatus of claim 13, wherein the second pitch is 1.0 mm or less.

15. The apparatus of claim 11, further comprising:
a capstan roller between each coarse pitch comb and the fine pitch comb.

16. The apparatus of claim 11, further comprising:
a transfer cap between each coarse pitch comb and the fine pitch comb.

17. The apparatus of claim 11, wherein the first channels are defined by fins.

18. The apparatus of claim 11, wherein the first channels are defined by pins.

19. The apparatus of claim 11, wherein the plurality of coarse pitch combs are arranged in a vertical stack.

20. The apparatus of claim 11, wherein the creel assembly comprises actively controlled spools.
